(19) United States
(12) Patent Application Publication
(10) Pub. No.: US 2026/0370688 A1
(43) Pub. Date: Nov. 19, 2026

(54) Cloud Component Split Brain Remediation

(71) Applicant: Zscaler, Inc., San Jose, CA (US)

(72) Inventor: Ramesh Ramar Andavar, Bangalore (IN)

(73) Assignee: Zscaler, Inc., San Jose, CA (US)

(21) Appl. No.: 19/251,518

(22) Filed: Jun. 26, 2025

(30) Foreign Application Priority Data
May 14, 2025 (IN) 202541046279

(51) Int. Cl. H04L 9/40; H04L 41/0895

(52) U.S. Cl. CPC H04L 63/20; H04L 41/0895

(57) ABSTRACT

Systems and methods for synchronizing a plurality of cloud controllers in a private cloud environment include determining, by each cloud controller of the plurality of cloud controllers, which cloud controller of the plurality of cloud controllers includes a sequence number representative of a most up-to-date configuration state; creating a connection between the plurality of cloud controllers and the cloud controller determined to have the sequence number representative of a most up-to-date configuration state based on the determination; performing, via the connection, a configuration synchronization between the plurality of cloud controllers and the cloud controller determined to have the sequence number representative of a most up-to-date configuration state to propagate the most up-to-date configuration data to the plurality of cloud controllers; and implementing a plurality of network security services using the plurality of cloud controllers based on synchronized configuration data, wherein the network security services include traffic forwarding, routing, and enforcement of tenant-specific policies.

### FIELD OF THE DISCLOSURE

The present disclosure relates generally to computing. More particularly, the present disclosure relates to systems and methods for cloud component split brain remediation.

### BACKGROUND OF THE DISCLOSURE

In multi-tenant cloud environments, cloud controllers are employed within tenant private cloud environments/networks to manage and enforce network policies, traffic routing, and secure communications for multiple tenants. As cloud deployments scale, particularly in hybrid environments involving both on-premises and cloud-based infrastructure, it becomes increasingly difficult to maintain a consistent configuration across all controllers. Variations in configuration data can lead to policy enforcement issues, degraded performance, and potential security vulnerabilities. Therefore, a reliable method is required for synchronizing configuration data across multiple cloud controllers to ensure consistent and secure service delivery to tenants.

### BRIEF SUMMARY OF THE DISCLOSURE

The present disclosure relates to systems and methods for synchronizing a plurality of cloud controllers in a private cloud environment. In various embodiments, the present disclosure includes a method having steps, a processing device configured to implement the steps, a cloud-based system configured to implement the steps, and as a non-transitory computer-readable medium storing instructions for programming one or more processors to execute the steps. The steps include determining, by each cloud controller of the plurality of cloud controllers, which cloud controller of the plurality of cloud controllers includes a sequence number representative of a most up-to-date configuration state; creating a connection between the plurality of cloud controllers and the cloud controller determined to have the sequence number representative of a most up-to-date configuration state based on the determination; performing, via the connection, a configuration synchronization between the plurality of cloud controllers and the cloud controller determined to have the sequence number representative of a most up-to-date configuration state to propagate the most up-to-date configuration data to the plurality of cloud controllers; and implementing a plurality of network security services using the plurality of cloud controllers based on synchronized configuration data, wherein the network security services include traffic forwarding, routing, and enforcement of tenant-specific policies.

The steps can further include calculating a total sequence number for each cloud controller based on individual sequence numbers corresponding to a plurality of configuration tables stored in each cloud controller. The determining can include comparing a hash value associated with the configuration data of the cloud controller having the highest sequence number with hash values of the configuration data of other cloud controllers to detect any differences in the configuration data even when the sequence number is the same. The steps can include establishing additional connections between cloud controllers with different hash values to facilitate synchronization of configuration data based on discrepancies identified in the hash values. The steps can include synchronizing only configuration data corresponding to tables in the connected cloud controllers that have lower sequence numbers than the respective tables stored in the cloud controller determined to have the highest sequence number. Performing the configuration synchronization can further include dynamically resynchronizing the configuration data when a new status message reveals an update to the highest sequence number in another cloud controller. Performing the configuration synchronization can include propagating configuration data incrementally between cloud controllers starting from a first cloud controller with the highest sequence number and moving sequentially through connected cloud controllers. The plurality of cloud controllers in the private cloud environment can be communicatively coupled to a cloud-based system, wherein the steps are performed in response to a loss of connection to the cloud-based system. The synchronized configuration data can include tenant-specific policy definitions, application connectivity configurations, and network security rules. The plurality of cloud controllers including the tenant-specific policy definitions, application connectivity configurations, and network security rules can be utilized to enforce private application access policies during a cloud outage.

### BRIEF DESCRIPTION OF THE DRAWINGS

The present disclosure is detailed through various drawings, where like components or steps are indicated by identical reference numbers for clarity and consistency.

FIG. 1 is a block diagram of a computing system 100 that may be used to implement various components described in this disclosure.

FIG. 2 is a flow diagram of a plurality of PCCs forming a mesh connection within a private cloud environment.

FIG. 3 is a flow diagram representing how a PCC establishes a connection to another PCC.

FIG. 4 outlines the flow of operations 400 for a client side after connection between PCCs.

FIG. 5 outlines the flow of operations 500 for a server side after connection between PCCs.

FIG. 6 is a flow diagram representing a termination flow between PCCs.

FIG. 7 is a diagram representing steps of a data synchronization process between a plurality of PCCs.

FIG. 8 is a diagram representing steps of a data synchronization process between a plurality of PCCs based on a hash value.

FIG. 9 illustrates a flowchart of a process for preventing split brain within cloud environments.

### DETAILED DESCRIPTION OF THE DISCLOSURE

Again, the present disclosure relates to systems and methods for synchronizing a plurality of cloud controllers in a private cloud environment. The systems and methods enable accurate, real-time propagation of the most up-to-date configuration data among cloud controllers to support network security services such as traffic forwarding, routing, and tenant-specific policy enforcement. In various embodiments, each cloud controller determines which among them holds the most recent configuration state by evaluating sequence numbers. Based on this determination, a synchronization connection is established to allow the propagation of the latest configuration data. This approach ensures all controllers operate using consistent configuration data while maintaining the flexibility to handle network topology variations and connectivity challenges.

### Example Computing System Architecture and Cloud Deployment

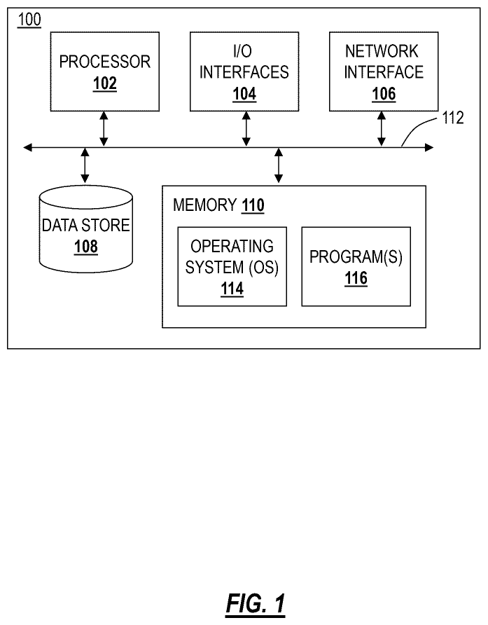

FIG. 1 is a block diagram of a computing system 100 that may be used to implement various components described in this disclosure. The computing system 100 can be implemented in many forms, including laptops, desktops, smartphones, tablets, physical servers, clusters of machines, virtual machines (VMs) running on hypervisors, or serverless computing frameworks. Regardless of the underlying infrastructure, the computing system 100 typically includes one or more processors 102, input/output (I/O) interfaces 104, a network interface 106, a data store 108, and memory 110. Note that FIG. 1 provides a simplified representation; in practice, the computing system 100 may include additional hardware and software elements. These components 102, 104, 106, 108, 110 are connected via a local interface 112, which can include various wired or wireless buses, high-speed interconnects, or switching fabrics. The local interface 112 may also include controllers, buffers, caches, drivers, repeaters, and receivers, along with addressing and control lines that facilitate efficient communication and resource sharing among components.

Each processor 102 is a hardware element—such as a central processing unit (CPU), multicore processor, system-on-chip (SoC), graphics processing unit (GPU), or a processing element within a larger compute cluster—designed to execute software instructions. These processors may be general-purpose or specialized, depending on performance, power efficiency, or workload needs. During operation, each processor 102 retrieves and executes instructions stored in memory 110, manages data exchanges with the data store 108, and oversees system 100 operations. In large-scale environments, multiple processors 102 may operate in parallel to handle elevated traffic and complex workloads.

The I/O interfaces 104 enable the computing system 100 to interact with external peripherals, allowing user input (e.g., via keyboards, touchscreens, or sensors) and system output (e.g., to displays or printers). Depending on the application, these I/O interfaces 104 may also support specialized devices used for maintenance, debugging, or other administrative functions. Meanwhile, the network interface 106 handles connectivity to external networks, which may include the Internet, private networks, or cloud environments. This network interface can use Ethernet, wireless local area networks (LANs), cellular connections, or virtualized cloud interfaces. By using secure transport protocols and encryption, data transmitted via the network interface 106 can remain protected, enabling the computing system 100 to participate safely in distributed or cloud-based deployments.

The data store 108 provides storage for both persistent and temporary data. It may include volatile memory (e.g., random access memory (RAM)) for high-speed operations and nonvolatile media (e.g., solid-state drives, hard disk drives, optical media) for long-term retention. In some deployments, the data store 108 may integrate with network-attached storage (NAS), storage area networks (SAN), or cloud-based storage solutions. These configurations can range from modest local setups to large-scale installations, potentially featuring global deduplication, compression, encryption at rest, and multi-site replication. The data store 108 can hold operational logs, configuration details, policy rules, program binaries, and cached computation results.

The memory 110 typically serves as the primary working memory for the processors 102. It may be composed of volatile elements (e.g., dynamic RAM (DRAM), double data rate (DDR), synchronous DRAM (SDRAM)) for fast access, as well as nonvolatile components such as flash memory or non-volatile RAM (NVRAM). The memory 110 can be distributed across nodes or servers to support the large-scale in-memory processing demanded by modern cloud services. Generally, the memory 110 stores the operating system (O/S) 114 and one or more programs 116. The O/S 114 handles core system tasks such as process scheduling, memory allocation, file management, and networking.

For Software-as-a-Service (SaaS) or other cloud-based components, the computing system 100 can be deployed in various ways: as a private cloud in a single organization's datacenter, a public cloud hosted by a third-party provider, or a hybrid cloud that combines both approaches for specific security, performance, or compliance considerations. Cloud computing abstracts physical hardware—servers, storage devices, and networks—into on-demand, scalable resources. This allows organizations to provision computing power, storage, and network bandwidth with minimal upfront costs, adjusting to fluctuating workloads seamlessly. According to the U.S. National Institute of Standards and Technology (NIST), cloud computing is “a model for enabling convenient, on-demand network access to a shared pool of configurable computing resources (e.g., networks, servers, storage, applications, and services) that can be rapidly provisioned and released with minimal management effort or service provider interaction.” Unlike traditional client-server environments, cloud computing typically delivers applications via a web interface, reducing the need for local installations and updates. Centralizing application hosting allows providers to uniformly release new features, apply security patches, and manage licensing. By using these SaaS models, end users can access software via browsers or lightweight clients, taking advantage of continuous improvements and frequent updates.

Various embodiments may utilize different forms of processing circuitry—general-purpose microprocessors, CPUs, digital signal processors (DSPs), network processors, GPUs, field programmable gate arrays (FPGAs), programmable logic devices (PLDs), or similar. This circuitry may be controlled by software, firmware, or a combination thereof, possibly alongside non-processor circuits to achieve the desired functionality. Specific tasks can also be handled by state machines or one or more application-specific integrated circuits (ASICs) that implement dedicated logic. In some cases, a hybrid approach may be adopted. Additionally, implementations can include a non-transitory computer-readable storage medium that stores computer-readable instructions. When executed by a device containing suitable processing circuitry, these instructions cause the system to perform the methods or algorithms described in this disclosure. Non-limiting examples of such storage media include hard disks, optical disks, magnetic devices, read-only memory (ROM) and its variants, flash memory, or other persistent/semi-persistent storage. Once stored, these instructions enable execution of the disclosed methods.

### Cloud-Based System

Various embodiments of the present invention describe a multi-tenant cloud-based system embodying a distributed platform designed to serve multiple tenants (organizations or customers) by enabling shared infrastructure while ensuring security, isolation, and scalability for each tenant. The system is composed of various interconnected components, each fulfilling specific roles, such as forwarding traffic, establishing secure connections, and facilitating seamless communication across public clouds and private environments. One such component is the agent applications, which act as lightweight software agents deployed on tenant devices or intermediary gateways. These agents forward traffic securely to the cloud system while enforcing tenant-specific traffic policies, providing authentication and encryption, and reporting connection health through continuous monitoring.

Another critical component is the application connectors, deployed in front of private applications hosted in tenant environments such as on-premises data centers or private clouds. These connectors create secure, outgoing tunnels to the cloud-based system, avoiding the need for inbound connections through the tenant's firewall. Application connectors also integrate with tenant identity systems to authenticate access requests, enforce application-level policies, and ensure reliability through features like load balancing and failover mechanisms. Alongside these, Private Service Edges (PSEs) serve as powerful nodes located at the edge of the tenant's infrastructure, acting as intermediaries between the private cloud and the multi-tenant system. These edges handle high-performance traffic routing, enforce security policies, optimize data by pre-processing or caching, and ensure seamless connectivity between tenant environments and the cloud.

At the center of this system is the cloud-based core platform, which manages all tenant traffic, policies, configurations, and operations. It incorporates a multi-tenant management framework to ensure data and operational isolation for tenants while enabling centralized control. The core system includes features like policy control and configuration stores that synchronize real-time updates to agents, service edges, and connectors. It also hosts Identity and Access Management (IAM) for tenant role-based access control, orchestrates services and health monitoring, and processes and stores data with strict segmentation to protect tenant-specific metadata. Through orchestration and scalability, the system dynamically adjusts resources to meet fluctuating tenant demands while ensuring fault tolerance and high availability.

The workflow of the system involves coordinated interactions among these components. Agent applications forward encrypted traffic from tenant devices to the system, while application connectors securely route private application traffic to the cloud using tunnels. PSEs manage traffic between the cloud and private resources, enforcing security and caching policies. The cloud-based core system acts as the central orchestrator, validating access requests, enforcing policies, processing data, and directing traffic efficiently. Additionally, the core system continually synchronizes configurations across all deployed components to ensure consistency with tenant-defined settings.

This system also incorporates key features like scalability, tenant isolation, end-to-end security, flexibility, and resilience. It dynamically scales to handle varying tenant demands, isolates tenant data and operations logically, encrypts and secures data at every layer, and ensures access to both public and private resources seamlessly. Redundancy mechanisms and fault-tolerant designs ensure high availability, and tenants can centrally manage their environment through a unified interface. For example, remote workers can securely access private on-premises applications through application connectors, while IoT devices in a manufacturing setup can use agent applications to forward data to the cloud. Financial institutions may use private service edges to maintain compliance while providing secure, low-latency access to cloud and private applications. In global systems, the cloud platform can dynamically load balance user connections to the nearest or highest-performing private service edge or application connector.

In summary, this multi-tenant cloud-based system provides a robust and scalable solution for businesses to connect, manage, and optimize hybrid cloud and on-premises resources. Its intelligent components work together to ensure secure, consistent, and reliable operations while delivering the flexibility required for modern, distributed environments.

### Split Brain

Split brain is a phenomenon in distributed computing where two or more components of a system lose the ability to communicate with each other but continue functioning independently, often resulting in inconsistencies and operational conflicts. Specifically, in cloud environments, split brain between two cloud components occurs when communication between the components is interrupted, often due to network partitioning, system configuration errors, latency spikes, regional outages, or software bugs. Each component, in the absence of communication, may assume it is the sole active component in the system, leading to problems such as conflicting writes, duplicate processing, misaligned dependencies, or diverging states.

For instance, in distributed databases, split brain can result in conflicting writes where multiple nodes independently modify the same data, causing data divergence when connectivity is restored. Similarly, systems with leader election protocols may experience multiple nodes simultaneously assuming the role of primary, leading to contradictory state changes. In distributed applications, duplicate task processing or inaccurate state synchronization can waste resources and cause logical errors. Distributed file systems may encounter file version conflicts or durability issues, while microservice architectures may experience inconsistent business logic when disconnected components operate with outdated state or dependencies.

The consequences of split brain are significant, as they can compromise data integrity, resource efficiency, and system functionality. Ultimately, split brain is a critical failure mode in cloud systems, especially in distributed architectures, where communication loss can wreak havoc on consistency and reliability. Preventing and recovering from split brain requires a combination of robust architectural designs, consensus algorithms, and deployment strategies to ensure synchronized operations and seamless recovery in the face of disruptions.

### Cloud Component Split Brain Remediation

The present disclosure provides systems and methods for remediating/preventing cloud component split brain. Private Cloud Controllers (PCCs) are on-premises cloud controller components that function similarly to Private Service Edges (PSEs) and application connectors. One of the primary roles of a PCC is to store customer configuration data, which is utilized by PSEs and application connectors to ensure proper functionality. This configuration data is stored in a Search Query Lite (SQLite) database on the PCCs. In scenarios such as cloud outages, where PSEs and application connectors cannot connect to a public broker, PCCs act as a fallback solution by providing the necessary configuration data to keep these components operational. Additionally, PCCs are designed to operate in isolated environments and may function entirely without connectivity to the public cloud in certain situations, making them well-suited for customers prioritizing control and independence in their private cloud setups.

It will be appreciated that the present systems and methods for remediating/preventing cloud component split brain can be implemented for any cloud component storing data thereon. Therefore, the present examples/embodiments regarding PCCs shall be contemplated as non-limiting examples.

Customers can deploy multiple PCCs within the same private cloud environment. However, connectivity dynamics introduce complexities. For instance, some PCCs might have access to the public cloud while others may not. This disparity can lead to differences in the configuration data across PCCs, as those with cloud connectivity may receive updated data from the public broker, whereas disconnected PCCs rely on their locally stored configurations. As a result, when components such as agent applications, application connectors, or PSEs connect to PCCs, their behavior might vary depending on the configuration data available at the time. These inconsistencies can lead to unpredictable or conflicting operations across the private cloud environment.

To address this issue, it is necessary to ensure that all PCCs within the private cloud maintain synchronized configuration data, regardless of their public cloud connectivity status. Achieving data consistency across all PCCs is critical for ensuring uniform behavior of dependent components, such as PSEs and application connectors, and for maintaining operational reliability across the private cloud. This calls for robust data synchronization mechanisms or distributed coordination strategies to continuously align configurations across PCCs, even in environments with limited connectivity or intermittent access to the public cloud. By implementing such measures, organizations can ensure consistency and seamless functionality throughout their private cloud infrastructure.

The primary goal of this feature is to define and implement a strategy to synchronize configuration data across all Private Cloud Controllers (PCCs) deployed within a private cloud environment. This synchronization must occur even in scenarios where one or more PCCs lack connectivity to the public cloud. The solution ensures that PCCs operating in isolated environments, or those with intermittent connectivity to public cloud services, can efficiently synchronize configuration data by communicating directly with other PCCs within the private cloud. This peer-to-peer synchronization ensures consistent and reliable behavior of all connected components across the entire private cloud infrastructure.

This feature is designed to be platform-agnostic and must function seamlessly across all platforms supported for hosting PCCs. These include traditional on-premises environments as well as cloud platforms such as Amazon Web Services (AWS), Azure, Google Cloud Platform (GCP), and others. By making the feature compatible with diverse deployment environments, it ensures that customers can benefit from consistent configuration data synchronization regardless of where their PCCs are hosted. This versatility also enables organizations to maintain uniform operations across hybrid and multi-cloud infrastructures.

The feature extends support to specialized environments like government-regulated clouds, including FedRAMP High and FedRAMP Moderate environments (often referred to as Fed Clouds). Configuration and operational behavior on these Fed Clouds will remain similar to those on commercial clouds, ensuring ease of adoption and standardization across deployments. Moreover, as this feature introduces no new compliance or sovereign cloud requirements, customers operating in sensitive or regulated environments can implement the functionality without impacting their existing regulatory frameworks or certifications.

This feature further represents a significant enhancement to existing PCC functionality, empowering customers to mitigate the risks of configuration inconsistencies in private cloud environments. Importantly, this new synchronization feature does not introduce any additional compliance or sovereign cloud requirements beyond those already supported by PCCs. It aligns with existing frameworks and standards, allowing organizations to adopt the feature without requiring additional certification efforts or adjustments to their regulatory compliance infrastructure. This ensures that introducing the feature is a straightforward process, particularly for customers with stringent compliance requirements.

In summary, this feature addresses the critical need to synchronize configuration data across multiple PCCs in a private cloud, regardless of public cloud connectivity. It is designed to function across diverse platforms, including commercial, government-regulated, and sovereign clouds, while requiring a one-time upgrade to the enhanced version of PCC. By doing so, it empowers organizations to achieve operational consistency and minimize disruptions in dynamic and hybrid cloud environments.

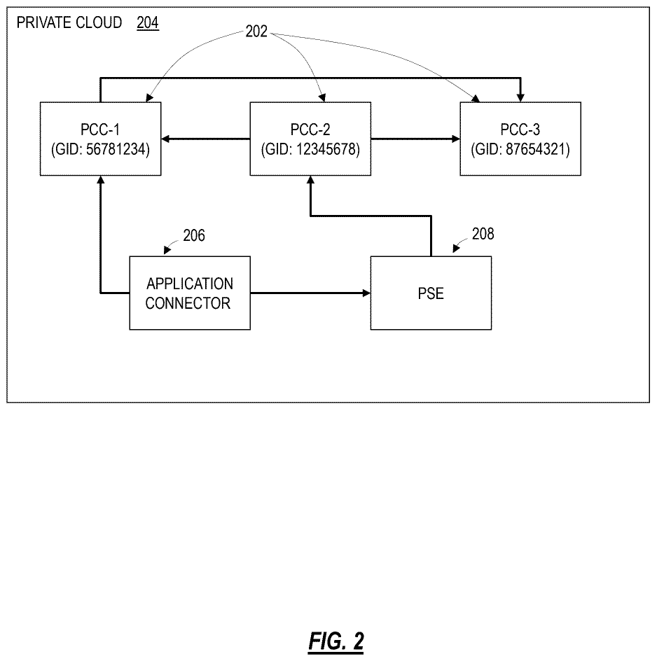

FIG. 2 is a flow diagram of a plurality of PCCs forming a mesh connection within a private cloud environment. FIG. 2 provides a per-cloud view of how PCCs 202 form mesh connections with one another within a private cloud 204. In this network, the Global Identifier (GID) plays a crucial role in determining the connections and roles of each PCC 202. The GID represents a form of configuration versioning, where a higher GID indicates a more up-to-date configuration on that PCC 202. For example, PCC-2, having a smaller GID, establishes connections with both PCC-1 and PCC-3 to synchronize its configuration. PCC-3, possessing the highest GID, acts as a server for both PCC-1 and PCC-2, enabling the other PCCs 202 to fetch the latest configuration data from it. Meanwhile, PCC-1 acts as a client to PCC-3 to receive the updated configuration and, at the same time, serves as a server for PCC-2, allowing it to further propagate the most current configuration. This hierarchical and version-based synchronization mechanism ensures that configuration consistency is maintained across the mesh, with newer configurations propagating naturally through the network to all PCCs 202. This approach optimizes connectivity, minimizes conflicts, and ensures the private cloud remains synchronized and up-to-date. Therefore, components that rely on the PCCs 202, such as application connectors 206 and PSEs 208, can utilize the most up-to-date configuration data.

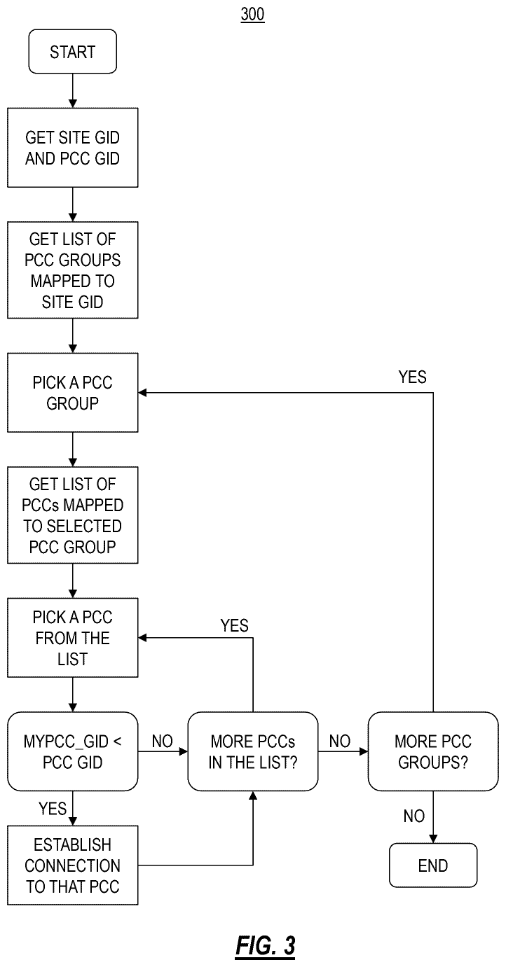

FIG. 3 is a flow diagram representing how a PCC establishes a connection to another PCC. The PCC status connection establishment diagram illustrates the process by which a PCC discovers and connects to other PCCs during its bootup sequence. This connection process is governed by the GID, which represents the configuration version of each PCC. During bootup, a PCC compares its GID with those of other available PCCs. If its GID is lower than that of another PCC, it will assume the role of a client and establish a connection to the other PCC, which effectively acts as a server. This GID-based connection logic ensures that PCCs with more up-to-date configurations (higher GIDs) can share the latest configuration data with PCCs that have older versions (lower GIDs). This approach not only facilitates dynamic role assignment but also ensures the efficient propagation of configuration updates across the entire private cloud network.

In various embodiments, the process 300 depicted outlines a method for establishing a status connection to a specific PCC (possibly a network or system component) based on SITE GID and PCC GID. It begins with retrieving the SITE GID (referred to as mysite_gid) and the PCC GID (referred to as mypcc_gid) for the given PCC. Following this, the process involves obtaining a list of PCC groups mapped to mysite_gid. From this list, a PCC group is selected, and the PCCs mapped to this group are retrieved. A PCC is then picked from this list, and a comparison is made to determine whether mypcc_gid is less than the PCC GID. If it is, a status connection is established with that PCC. If not, the process checks if more PCCs are available in the list. If so, another PCC is picked and the comparison is repeated. If no more PCCs are available, the process checks for additional PCC groups in the list and repeats the group and PCC selection steps accordingly. If no further PCC groups are present, the process ends. This structured loop ensures that all available PCC groups and PCCs are iterated through systematically to establish a valid status connection based on the given conditions.

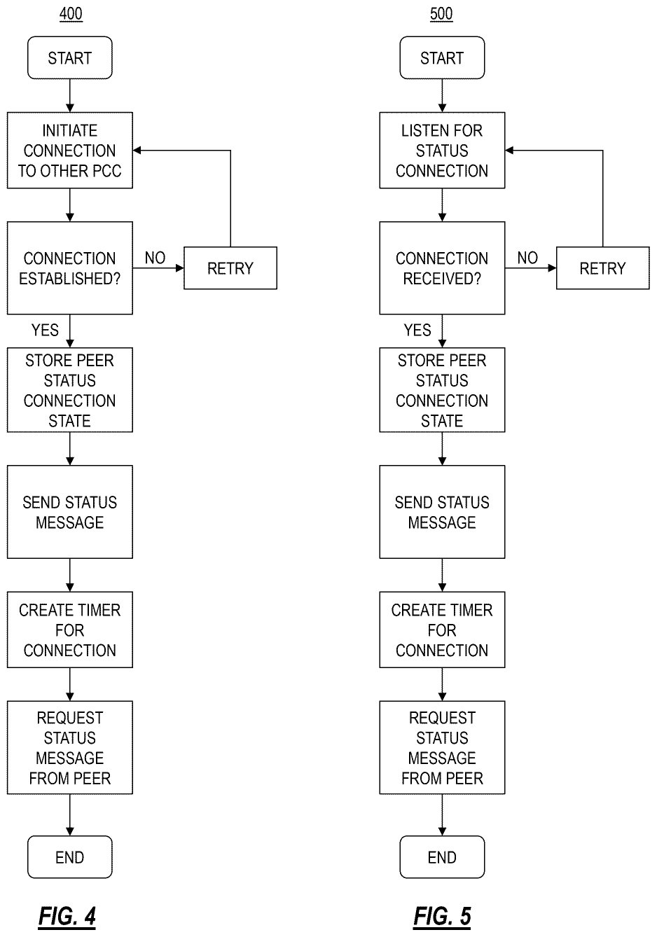

FIG. 4 outlines the flow of operations 400 for a client side after connection between PCCs. FIG. 5 outlines the flow of operations 500 for a server side after connection between PCCs. Once the connection is initialized, both the client and server sides will store the peer status connection state in a hash table, using the peer's GID as the key. This ensures that connection states are tracked efficiently and tied to the relevant configuration version of the peer. Following this, the PCCs register to receive status messages from their peers, enabling ongoing communication and status monitoring. After registration, they send an initial status message to establish the active communication baseline. Additionally, a timer is created to automatically send status messages every minute, maintaining consistent updates between the PCCs. In cases where the connection is disconnected or fails to establish, the client side initiates a reconnection process that retries the connection with an exponential backoff, capped at a maximum retry interval, for example 30 seconds. This method ensures robust connectivity and consistent status synchronization, even in the presence of temporary network disruptions or failures.

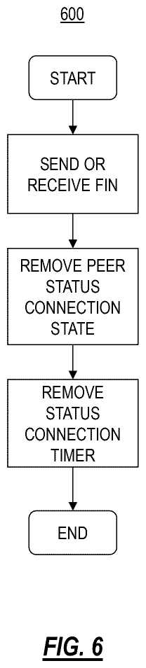

FIG. 6 is a flow diagram representing a termination flow 600 between PCCs. The termination flow for a PCC status connection is triggered under specific circumstances such as a network issue causing the connection to disconnect, a PCC restarting or crashing, or a PCC being deleted from the environment. Additionally, a status connection will terminate if no packets, including keepalives, are received for a defined duration, for example 5 minutes. When a status connection is disconnected, the associated status connection state is removed from its hash table, and the timer for sending periodic updates is also cleared. This cleanup process is performed equally on both the client and server sides whenever a FIN (Finish) or RST (Reset) packet is sent or received, ensuring that any residual connection state or resources tied to the session are effectively removed. This termination and cleanup method ensures that the system remains efficient and avoids stale or invalid connection states, maintaining optimal behavior within the private cloud network.

When the PCC configuration connection to the public broker goes down, the PCC initiates a reconnection process based on the downtime settings configured in the tenants cloud configuration settings. By default, the maximum downtime allowed can be 2 minutes, or any other period. During this period, the PCC actively attempts to reconnect to the public cloud broker. If reconnection fails, the PCC identifies the best available PCC within the network to switch the configuration connection to ensure continued operation. Once the configuration connection is successfully switched to another PCC, the system continually checks whether the PCC control connection to the public broker has been restored.

If the control connection to the public broker is established, the PCC switches its configuration connection back to the public broker. However, if the control connection remains down, the PCC continues to rely on the best available PCC within the private cloud. The method includes several checks to optimize operations. For example, if the PCC itself is determined to be the best available option for the configuration connection, no further action is required. Similarly, if the configuration connection is already connected to the best PCC selected, no changes are made. However, if the configuration connection is not yet connected to the selected PCC, the PCC switches its configuration connection to align with the best available PCC. This process ensures seamless operation and minimizes disruption when public cloud connectivity is lost, allowing PCCs to dynamically adjust and maintain configuration continuity across the private cloud infrastructure.

The selection of the best PCC for configuration connection is determined based on the status messages sent by other PCCs within the private cloud network. The process begins by gathering all the status messages from the other PCCs and compiling them into a list. The relative distance between the current PCC and each of the other PCCs is calculated, and the list is sorted based on this distance. Next, the list is filtered to include only PCCs with an “UP” status, which indicates they are operational and available for connection. If any PCCs are present in the filtered list, their effective load is calculated to assess their current resource utilization. The PCC with the least effective load is then selected as the best candidate for connection.

If there are no PCCs in the filtered list, the original unfiltered list is sorted in descending order based on the total maximum sequence number, which reflects the most up-to-date configuration (as a higher sequence number indicates newer data). The greatest total maximum sequence number is retrieved from the first entry in the list. If the current PCC's total maximum sequence number is less than this value, the PCC with the highest total maximum sequence number is selected as the best option for connection.

Next, all PCCs that match the current PCC's total maximum sequence number are identified and grouped into a new list. If no PCCs appear in this list, it implies that the current PCC is the best candidate, as it already has the most recent configuration. However, if entries exist in this list, the PCC iterates over these candidates to find a PCC whose hash value differs from its own, indicating a viable alternative for connection. If all PCCs in the list share the same hash value as the current PCC's hash, it signifies that all PCCs have the latest configuration, confirming that the current PCC remains the best choice.

This multi-step process ensures that configuration connections are strategically assigned to the most optimal PCC based on factors like operational status, resource load, configuration freshness, and hash value uniqueness. This minimizes resource contention and guarantees that the private cloud continues to operate efficiently and with consistent configuration data, even under dynamic conditions.

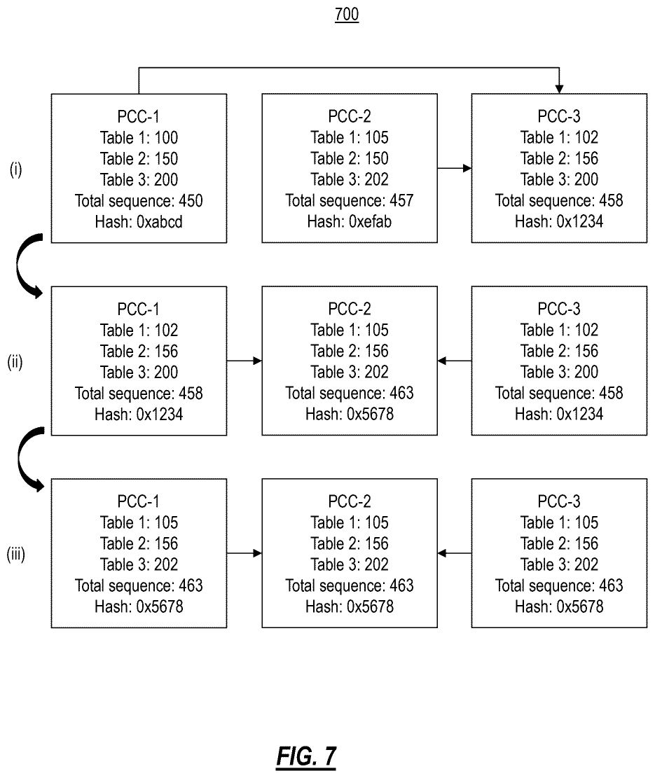

FIG. 7 is a diagram representing steps of a data synchronization process 700 between a plurality of PCCs. The diagram illustrates how the latest configuration data is synchronized among PCCs using the total max sequence number, which reflects the combined versioning of various configuration tables in each PCC. In this example, the configuration includes three tables (table 1, table 2, and table 3), each having its own sequence number, representing its version in each PCC. Since each PCC may have different sequence numbers for individual tables, these are aggregated into a total max sequence number for that PCC.

Initially, in the first cycle (i), PCC-3 has the highest total max sequence number of 458, indicating that it holds the most up-to-date configuration overall. As a result, both PCC-1 and PCC-2 connect to PCC-3 to synchronize their data. During the sync process, each table is compared individually to determine if it needs to be updated. For instance, in table 1, PCC-1 has a sequence number of 100, PCC-2 has 105, and PCC-3 has 102. Based on these values, PCC-1 updates its local table 1 from PCC-3 to reflect the newer version, whereas PCC-2 does not perform an update since its local table 1 already has a higher sequence number than table 1 in PCC-3. Each table is handled in a similar manner during the synchronization process, ensuring that only outdated tables are updated.

When the next status messages are exchanged among the PCCs, in cycle (ii), it is determined that PCC-2 now has the highest total max sequence number of 463. Consequently, both PCC-1 and PCC-3 connect to PCC-2 for another round of synchronization, updating their tables as required to align with the latest configurations. Finally, during the subsequent status message exchange, in cycle (iii), it is observed that all PCCs now share the same total max sequence number and hash value. This indicates that all PCCs have fully synchronized configurations and are consistent with one another. At this point, the configuration connection remains with PCC-2, as all PCCs are now up to date. This dynamic and table-specific synchronization process ensures efficiency, consistency, and alignment across the entire private cloud infrastructure.

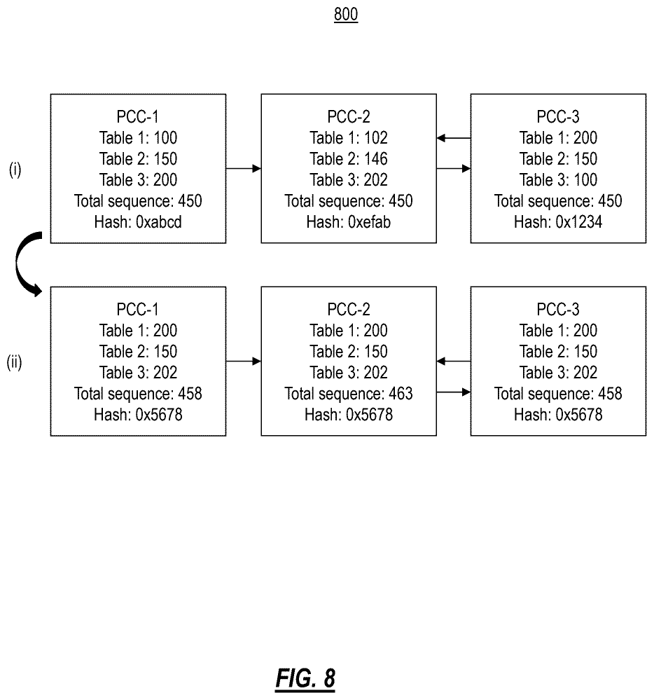

FIG. 8 is a diagram representing steps of a data synchronization process 800 between a plurality of PCCs based on a hash value. The diagram demonstrates how the latest configuration data is synchronized among PCCs based on differences in their hash values. For example, at the end of the process shown in FIG. 7, if each PCC had a same total hash value, but different hash values, this process would take place. In the scenario shown in FIG. 8, all PCCs share the same total max sequence number of 450, indicating they have the same overall configuration version. However, the different hash values across the PCCs reveal that their data is not identical, suggesting discrepancies within specific configuration tables. To resolve this, each PCC connects to another PCC with a different hash value for synchronization. For example, PCC-1 connects to PCC-2, PCC-2 connects to PCC-3, and PCC-3 connects back to PCC-2. This process ensures that the differences in configuration data are reconciled. By the end of the synchronization process, all PCCs share identical hash values, confirming that the configuration data has been unified and updated across all nodes. This approach ensures data consistency and alignment across the private cloud infrastructure while addressing partial mismatches in configuration data, even when the sequence numbers are the same.

In certain scenarios, not all PCCs in a private cloud may be able to form direct mesh connections with each other due to network constraints or topology limitations. In an example, PCC-1 can establish a connection with PCC-2, PCC-2 can connect to PCC-4, and PCC-3 and PCC-4 can both connect to PCC-5. In this case, if PCC-1 holds the latest configuration data, the synchronization process will propagate the data across the network incrementally. PCC-2 will first synchronize with PCC-1 to obtain the updated data. Then, PCC-4 will sync with PCC-2, followed by PCC-5 syncing with PCC-4. Finally, PCC-3 will synchronize from PCC-5, completing the process. Through this step-by-step chain of synchronization, the latest configuration data is propagated seamlessly across all the PCCs, ensuring that eventually all nodes in the network reach a consistent and up-to-date configuration state, despite the lack of direct connections between some of the PCCs.

The disclosed systems and methods encompass several key steps that collectively ensure efficient configuration synchronization among cloud controllers (or other cloud components) in a multi-tenant cloud-based system. In various embodiments, methods include determining which cloud controller holds the most up-to-date configuration data, synchronizing configurations across controllers based on this determination, and utilizing the synchronized data to implement essential network security services.

To determine the most current configuration, each cloud controller within a private cloud environment retrieves and evaluates a sequence number indicative of its configuration state. Controllers exchange status messages containing these sequence numbers, as well as hash values that represent the integrity of their configuration data. In some instances, a total sequence number is calculated by aggregating sequence numbers from multiple configuration tables stored within each controller. The controller with the highest sequence number is identified as having the most up-to-date configuration. To further ensure data consistency, hash values are compared across controllers; if discrepancies exist despite matching sequence numbers, additional synchronization is initiated to resolve the inconsistencies.

Once the controller with the most recent configuration is identified, a connection is established between it and the other controllers. This connection facilitates the synchronization process, wherein only configuration data corresponding to tables with lower sequence numbers in the receiving controllers is synchronized. Synchronization is dynamic and can be triggered when new status messages indicate updated sequence numbers. In scenarios where direct mesh connections among controllers are not viable due to connectivity limitations, an alternative chain-like synchronization strategy is used. In this approach, configuration data propagates incrementally from the most current controller through a sequence of connected controllers. The entire synchronization process is conducted using secure communication protocols to maintain the integrity and confidentiality of the configuration data.

Following synchronization, cloud controllers execute various network security services. These include forwarding traffic from agent applications to designated controllers, managing secure connections to private applications via application connectors, and enforcing tenant-specific access and routing policies through private service edges. Additionally, synchronized controllers support dynamic load balancing, near-real-time policy updates, and failover functionality in the event of controller failures.

The method also facilitates scalability and reliability. It allows cloud controllers to scale in response to increased tenant traffic while ensuring that synchronized configurations are maintained across all instances. To enhance resilience, the method incorporates mechanisms for detecting synchronization failures and initiating reconnection attempts with backoff intervals. A conflict resolution algorithm ensures data consistency by prioritizing the most current configuration data during synchronization conflicts.

Examples of the configuration data synchronized among controllers include tenant-specific policy definitions, application connectivity configurations, and network security rules. The advantages of the invention are numerous as it maintains consistent configurations across cloud controllers, supports dynamic scaling and failover, ensures secure and efficient network service delivery, provides robust synchronization even under variable network conditions, and reduces administrative overhead by mitigating configuration drift risks.

This invention is particularly applicable to enterprise cloud deployments, hybrid cloud environments, service provider networks, and any infrastructure that uses cloud controllers to manage network security services. In conclusion, the disclosed methods effectively address the challenges of configuration synchronization in distributed cloud environments, ensuring cloud controllers function in a unified, secure, and resilient manner, thereby enhancing the delivery of tenant-specific services at scale.

### Process for Preventing Split Brain Within Cloud Environments

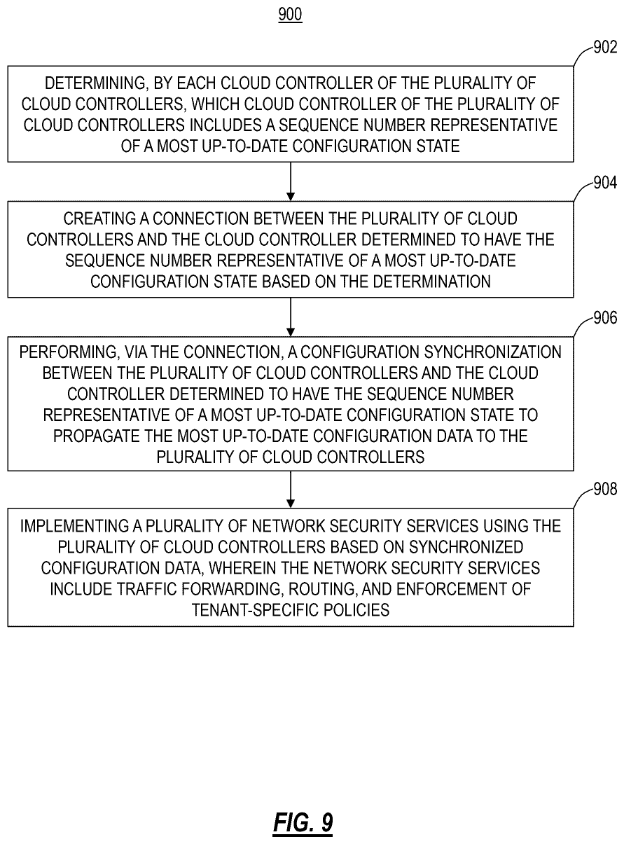

FIG. 9 illustrates a flowchart of a process 900 for preventing split brain within cloud environments. In various embodiments, the process 900 can be implemented in multiple ways: as a method comprising distinct steps, via the computing system 100 configured to execute those steps, via a cloud system configured to do so, or through a non-transitory computer-readable medium that stores instructions causing one or more processors to perform the steps. This flexibility allows process 900 to be adapted to various system architectures and deployment scenarios.

The process 900 includes determining, by each cloud controller of the plurality of cloud controllers, which cloud controller of the plurality of cloud controllers includes a highest sequence number representative of a most up-to-date configuration state (step 902); creating a connection between the plurality of cloud controllers and the cloud controller determined to have the highest sequence number based on the determination (step 904); performing, via the connection, a configuration synchronization between the plurality of cloud controllers and the cloud controller determined to have the highest sequence number to propagate the most up-to-date configuration data to the plurality of cloud controllers (step 906); and implementing a plurality of network security services using the plurality of cloud controllers based on synchronized configuration data, wherein the network security services include traffic forwarding, routing, and enforcement of tenant-specific policies (step 908).

The process 900 can further include calculating a total sequence number for each cloud controller based on individual sequence numbers corresponding to a plurality of configuration tables stored in each cloud controller. The determining can include comparing a hash value associated with the configuration data of the cloud controller having the highest sequence number with hash values of the configuration data of other cloud controllers to detect any differences in the configuration data even when the sequence number is the same. The steps can include establishing additional connections between cloud controllers with different hash values to facilitate synchronization of configuration data based on discrepancies identified in the hash values. The steps can include synchronizing only configuration data corresponding to tables in the connected cloud controllers that have lower sequence numbers than the respective tables stored in the cloud controller determined to have the highest sequence number. Performing the configuration synchronization can further include dynamically resynchronizing the configuration data when a new status message reveals an update to the highest sequence number in another cloud controller. Performing the configuration synchronization can include propagating configuration data incrementally between cloud controllers starting from a first cloud controller with the highest sequence number and moving sequentially through connected cloud controllers. The plurality of cloud controllers in the private cloud environment can be communicatively coupled to a cloud-based system, wherein the steps are performed in response to a loss of connection to the cloud-based system. The synchronized configuration data can include tenant-specific policy definitions, application connectivity configurations, and network security rules. The plurality of cloud controllers including the tenant-specific policy definitions, application connectivity configurations, and network security rules can be utilized to enforce private application access policies during a cloud outage.

### Conclusion

In this disclosure, including the claims, the phrases “at least one of” or “one or more of” when referring to a list of items mean any combination of those items, including any single item. For example, the expressions “at least one of A, B, or C,” “at least one of A, B, and C,” “one or more of A, B, or C,” and “one or more of A, B, and C” cover the possibilities of: only A, only B, only C, a combination of A and B, A and C, B and C, and the combination of A, B, and C. This can include more or fewer elements than just A, B, and C. Additionally, the terms “comprise,” “comprises,” “comprising,” “include,” “includes,” and “including” are intended to be open-ended and non-limiting. These terms specify essential elements or steps but do not exclude additional elements or steps, even when a claim or series of claims includes more than one of these terms.

Although operations, steps, instructions, blocks, and similar elements (collectively referred to as “steps”) are shown or described in the drawings, descriptions, and claims in a specific order, this does not imply they must be performed in that sequence unless explicitly stated. It also does not imply that all depicted operations are necessary to achieve desirable results. In the drawings, descriptions, and claims, extra steps can occur before, after, simultaneously with, or between any of the illustrated, described, or claimed steps. Multitasking, parallel processing, and other types of concurrent processing are also contemplated. Furthermore, the separation of system components or steps described should not be interpreted as mandatory for all implementations; also, components, steps, elements, etc. can be integrated into a single implementation or distributed across multiple implementations.

While this disclosure has been detailed and illustrated through specific embodiments and examples, it should be understood by those skilled in the art that numerous variations and modifications can perform equivalent functions or achieve comparable results. Such alternative embodiments and variations, even if not explicitly mentioned but that achieve the objectives and adhere to the principles disclosed herein, fall within the spirit and scope of this disclosure. Accordingly, they are envisioned and encompassed by this disclosure and are intended to be protected under the associated claims. In other words, the present disclosure anticipates combinations and permutations of the described elements, operations, steps, methods, processes, algorithms, functions, techniques, modules, circuits, and so on, in any conceivable order or manner—whether collectively, in subsets, or individually—thereby broadening the range of potential embodiments.

What is claimed is:

1. A method for synchronizing a plurality of cloud controllers in a private cloud environment, the method comprising steps of:
determining, by each cloud controller of the plurality of cloud controllers, which cloud controller of the plurality of cloud controllers includes a most up-to-date configuration state based on a sequence number;
creating a connection between the plurality of cloud controllers and the cloud controller determined to have the most up-to-date configuration state based on the determination;
performing, via the connection, a configuration synchronization between the plurality of cloud controllers and the cloud controller determined to have the most up-to-date configuration state to propagate most up-to-date configuration data to the plurality of cloud controllers; and
implementing a plurality of network security services using the plurality of cloud controllers based on synchronized configuration data, wherein the network security services include traffic forwarding, routing, and enforcement of tenant-specific policies.

2. The method of claim 1, wherein the determining further includes calculating a total sequence number for each cloud controller based on individual sequence numbers corresponding to a plurality of configuration tables stored in each cloud controller.

3. The method of claim 1, wherein the determining includes comparing a hash value associated with the configuration data of the cloud controller having the most up-to-date configuration state with hash values of the configuration data of other cloud controllers to detect any differences in the configuration data even when the sequence number is the same.

4. The method of claim 3, further comprising establishing additional connections between cloud controllers with different hash values to facilitate synchronization of configuration data based on discrepancies identified in the hash values.

5. The method of claim 1, wherein performing the configuration synchronization comprises synchronizing only configuration data corresponding to tables in the connected cloud controllers that have sequence numbers representative of an outdated configuration state as compared to the respective tables stored in the cloud controller determined to have the most up-to-date configuration state.

6. The method of claim 1, wherein performing the configuration synchronization further comprises dynamically resynchronizing the configuration data when a new status message reveals an update to a sequence number representative of the most up-to-date configuration state in another cloud controller.

7. The method of claim 1, wherein performing the configuration synchronization includes propagating configuration data incrementally between cloud controllers starting from a first cloud controller with a most up-to-date configuration state and moving sequentially through connected cloud controllers.

8. The method of claim 1, wherein the plurality of cloud controllers in the private cloud environment are communicatively coupled to a cloud-based system, and wherein the steps are performed in response to a loss of connection to the cloud-based system.

9. The method of claim 1, wherein the synchronized configuration data includes tenant-specific policy definitions, application connectivity configurations, and network security rules.

10. The method of claim 9, wherein the plurality of cloud controllers including the tenant-specific policy definitions, application connectivity configurations, and network security rules are utilized to enforce private application access policies during a cloud outage.

11. A non-transitory computer-readable medium comprising instructions for synchronizing a plurality of cloud controllers in a private cloud environment that, when executed, cause one or more processors to perform steps of:
determining, by each cloud controller of the plurality of cloud controllers, which cloud controller of the plurality of cloud controllers includes a most up-to-date configuration state based on a sequence number;
creating a connection between the plurality of cloud controllers and the cloud controller determined to have the most up-to-date configuration state based on the determination;
performing, via the connection, a configuration synchronization between the plurality of cloud controllers and the cloud controller determined to have the most up-to-date configuration state to propagate most up-to-date configuration data to the plurality of cloud controllers; and
implementing a plurality of network security services using the plurality of cloud controllers based on synchronized configuration data, wherein the network security services include traffic forwarding, routing, and enforcement of tenant-specific policies.

12. The non-transitory computer-readable medium of claim 11, wherein the determining further includes calculating a total sequence number for each cloud controller based on individual sequence numbers corresponding to a plurality of configuration tables stored in each cloud controller.

13. The non-transitory computer-readable medium of claim 11, wherein the determining includes comparing a hash value associated with the configuration data of the cloud controller having the most up-to-date configuration state with hash values of the configuration data of other cloud controllers to detect any differences in the configuration data even when the sequence number is the same.

14. The non-transitory computer-readable medium of claim 13, further comprising establishing additional connections between cloud controllers with different hash values to facilitate synchronization of configuration data based on discrepancies identified in the hash values.

15. The non-transitory computer-readable medium of claim 11, wherein performing the configuration synchronization comprises synchronizing only configuration data corresponding to tables in the connected cloud controllers that have sequence numbers representative of an outdated configuration state as compared to the respective tables stored in the cloud controller determined to have the most up-to-date configuration state.

16. The non-transitory computer-readable medium of claim 11, wherein performing the configuration synchronization further comprises dynamically resynchronizing the configuration data when a new status message reveals an update to a sequence number representative of the most up-to-date configuration state in another cloud controller.

17. The non-transitory computer-readable medium of claim 11, wherein performing the configuration synchronization includes propagating configuration data incrementally between cloud controllers starting from a first cloud controller with a most up-to-date configuration state and moving sequentially through connected cloud controllers.

18. The non-transitory computer-readable medium of claim 11, wherein the plurality of cloud controllers in the private cloud environment are communicatively coupled to a cloud-based system, and wherein the steps are performed in response to a loss of connection to the cloud-based system.

19. The non-transitory computer-readable medium of claim 11, wherein the synchronized configuration data includes tenant-specific policy definitions, application connectivity configurations, and network security rules.

20. The non-transitory computer-readable medium of claim 19, wherein the plurality of cloud controllers including the tenant-specific policy definitions, application connectivity configurations, and network security rules are utilized to enforce private application access policies during a cloud outage.
